(19) United States
(12) Patent Application Publication
(10) Pub. No.: US 2012/0239340 A1
(43) Pub. Date: Sep. 20, 2012

(54) LITHIUM CELL SIMULATING DEVICE

(75) Inventors: HUNG-CHIH CHEN, NEW TAIPEI CITY (TW); CHING-FENG HSIEH, TAIPEI CITY (TW)

(73) Assignee: ASKEY COMPUTER CORP., NEW TAIPEI CITY (TW)

(21) Appl. No.: 13/150,781

(22) Filed: Jun. 1, 2011

(30) Foreign Application Priority Data
Mar. 15, 2011 (TW) 100108711

(51) Int. Cl. G06F 19/00

(52) U.S. Cl. 702/123

(57) ABSTRACT

A lithium cell simulating device includes a programmable power supplying module for generating multiple powers; a lithium cell status controlling module for generating multiple lithium cell statuses; a load setting module for simulating a lithium cell status; a device under test (DUT) status detecting module for detecting whether a device under test (DUT) is actuated; and a control unit for controlling a test procedure in its entirety. Accordingly, the lithium cell simulating device is suitable for use with DUTs of different power requirements and effective in simulating a charging/discharging status, a battery level status, and a battery temperature status under different conditions in the absence of a lithium cell and other complicated test apparatuses, so as to enable a great reduction of costs incurred in performing a test on a production line.

### CROSS-REFERENCE TO RELATED APPLICATION

This non-provisional application claims priority under 35 U.S.C. §119(a) on Patent Application No(s).100108711 filed in Taiwan, R.O.C. on Mar. 15, 2011, the entire contents of which are hereby incorporated by reference.

### FIELD OF TECHNOLOGY

The present invention relates to charging simulating devices, and more particularly, to a lithium cell simulating device for simulating a lithium cell of an electronic device.

### BACKGROUND

A portable electronic product usually works in conjunction with a rechargeable cell, such as a lithium cell. The portable electronic product charges the rechargeable cell directly, using an external power supply. The portable electronic product usually has an overcharging protection mechanism for protecting the portable electronic product proper and the rechargeable cell.

Hence, the overcharging protection mechanism of portable electronic products undergoes, during a manufacturing process thereof, a test to verify whether the overcharging protection provided is up to standard. In this regard, a conventional test entails conducting the test on actual rechargeable cells. As a result, during a mass production process, not only are a lot of rechargeable cells kept ready in hand for performing the test thereon, but the rechargeable cells incur additional maintenance costs in order to sustain their service life and performance. All these not only increase the testing costs but render the test inefficient.

### SUMMARY

It is an objective of the present invention to provide a lithium cell simulating device for simulating various “must test” conditions and charging criteria of a lithium cell being charged, such that the testing criteria can be easily satisfied or changed, so as to reduce testing costs.

In order to achieve the above and other objectives, the present invention provides a lithium cell simulating device comprising: a programmable power supplying module for converting an external power into a set power to be supplied to a device under test (DUT); a lithium cell status controlling module for providing a lithium cell status signal to the DUT; a load setting module adapted to set a battery level and a charging mode and electrically connected to the DUT so as to receive the set power via the DUT; a control unit electrically connected to the programmable power supplying module, the lithium cell status controlling module, and the load setting module, adapted to allow the programmable power supplying module to provide the set power suitable for use by the DUT, adapted to allow the lithium cell status controlling module to set different statuses of the lithium cell according to preset testing criteria, and adapted to allow the load setting module to set different battery levels and different charging modes according to the preset testing criteria; and a device under test (DUT) status detecting module electrically connected to the DUT and the control unit to generate a status signal for indicating whether the DUT is ON or not and send the status signal to the control unit.

In an embodiment, the lithium cell simulating device further comprises: a lithium cell anti-theft identification module for providing, under the control of the control unit, an identifier signal to the DUT for verification. Upon completion of the verification, the control unit starts the testing procedure only when the status signal for indicating whether the DUT is ON or not indicates that the DUT is ON.

Accordingly, the lithium cell simulating device is suitable for use with DUTs of different power requirements and effective in simulating a charging/discharging status, a battery level status, and a battery temperature status under different conditions in the absence of a lithium cell and other complicated test apparatuses, so as to enable a great reduction of costs incurred in performing a test on a production line.

### BRIEF DESCRIPTION OF THE DRAWINGS

Objectives, features, and advantages of the present invention are hereunder illustrated with specific embodiments in conjunction with the accompanying drawings, in which:

FIG. 1 is a functional block diagram of a lithium cell simulating device according to an embodiment of the present invention; and

FIG. 2 is a functional block diagram of the lithium cell simulating device according to another embodiment of the present invention.

### DETAILED DESCRIPTION

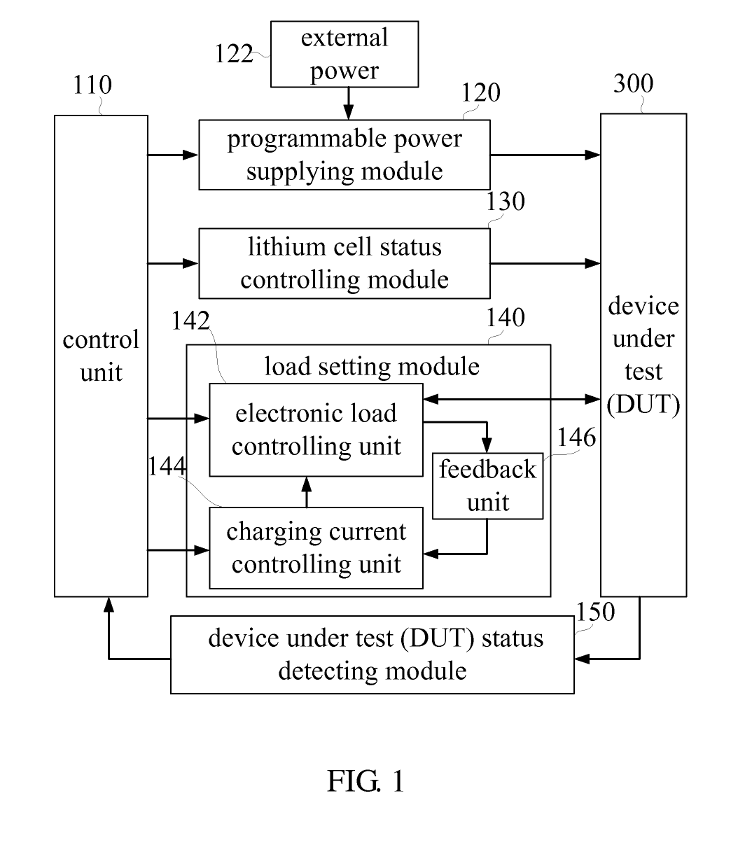

Referring to FIG. 1, there is shown a functional block diagram of a lithium cell simulating device according to an embodiment of the present invention. It is important that a lithium cell for use with a device under test (DUT) 300 should better have a charging/discharging protection function; hence, the present invention provides a test device that works quickly but incurs a low cost. To be specific, the present invention provides a lithium cell simulating device for simulating different conditions of a lithium cell disposed in the DUT 300 to enable the DUT 300 to perform tests on various functions of the lithium cell. In general, in case the lithium cell is overcharged, the DUT 300 should be able to interrupt the charging procedure in real time.

A lithium cell simulating device of the present invention comprises a control unit 110, a programmable power supplying module 120, a lithium cell status controlling module 130, a load setting module 140, and a device under test (DUT) status detecting module 150.

With a programmable adjustable variable resistance or any transformer device, for example, the programmable power supplying module 120 converts an external power 122 into a supplying power suitable for use by the DUT 300. For instance, the programmable power supplying module 120 is implemented in the form of a utility power supply for supplying power to the DUT 300 and adapted to charge a rechargeable cell (the load setting module 140) disposed inside the DUT 300.

The lithium cell status controlling module 130 is for simulating a situation likely to happen to a cell, such as a high temperature status, so as to test and determine whether a rechargeable cell protection mechanism of the DUT 300 is functioning well. Lithium cells usually have an overcharging protection mechanism that operates by means of temperature detection. The overcharging protection mechanism sends a signal to a charging structure that supplies power. Hence, the lithium cell status controlling module 130 can be connected to a contact of the DUT 300, wherein the contact is dedicated to receiving the signal. A simulation-specific signal is sent to the DUT 300 to test and determine whether the protection function of the DUT 300 is good. In an embodiment, the lithium cell status controlling module 130 is a temperature-resistance controlling module, wherein a normal temperature status or a high temperature status of a rechargeable cell is simulated by setting a resistance. Alternatively, the aforesaid simulation can be effectuated by using a temperature sensor and controlling the way of sending out a signal therefrom.

The load setting module 140 is for simulating the battery level of a rechargeable cell in the DUT 300 and the required charging current thereof, so as to simulate various situations in which the DUT 300 is charging the rechargeable cell thereof. An example of the charging situations is: the DUT 300 gets connected to a utility power supply or another external power so as to charge the rechargeable cell therein.

In an embodiment, the load setting module 140 comprises an electronic load controlling unit 142, a charging current controlling unit 144, and a feedback unit 146. Under the control of the control unit 110, the electronic load controlling unit 142 sets different voltage levels so as to simulate the battery level. The charging current controlling unit 144 not only simulates the charging of the electronic load controlling unit 142 but also sets, under the control of the control unit 110, different charging modes according to different testing criteria, respectively, such as a constant current charging mode, a constant voltage charging mode, or a trickling charging mode. The feedback unit 146 is electrically connected to the electronic load controlling unit 142 and the charging current controlling unit 144, so as to feed back the battery level of the electronic load controlling unit 142 to the charging current controlling unit 144.

The DUT status detecting module 150 is electrically connected to the DUT 300 and the control unit 110 and adapted to generate a status signal for indicating whether the DUT 300 is ON or not, and send the status signal to the control unit 110, such that the control unit 110 can execute a test procedure after the DUT 300 has confirmed the completion of the assembly of the lithium cell simulating device, that is, the completion of power connection.

The control unit 110 controls the test procedure in its entirety. A user sets the testing criteria, for example, setting the charging modes of a lithium cell with a low, intermediate, and high battery levels, respectively, or setting the charging modes of a lithium cell operating in a normal temperature status or a high temperature status. Afterward, the control unit 110 starts to test and determine whether a response given by the DUT 300 is normal, or determine whether the rechargeable cell protection mechanism is functioning well.

The control unit 110 is electrically connected to the programmable power supplying module 120, the lithium cell status controlling module 130, and the load setting module 140. The control unit 110 enables the programmable power supplying module 120 to provide a set power supply suitable for use with the DUT 300. Furthermore, the control unit 110 enables the lithium cell status controlling module 130 to set different statuses, such as a high temperature status or a normal temperature status, of the lithium cell according to preset testing criteria. Furthermore, the control unit 110 enables the load setting module 140 to set different battery levels and different charging modes according to the preset testing criteria.

For example, the lithium cell simulating device of the present invention operates by taking the steps below.

Under the control of the control unit 110, the programmable power supplying module 120 supplies an appropriate power to the DUT 300, and the load setting module 140 simulates different battery levels, such as low, intermediate, and high voltage levels, of a lithium cell.

Under the control of the control unit 110, the lithium cell status controlling module 130 sets a required cell status, such as a normal temperature status or a high temperature status.

Under the control of the control unit 110, the status of the required charging current, such as a constant current charging mode, a constant voltage charging mode, or a trickling charging mode, is set.

The user has the DUT 300 connected to the lithium cell simulating device. A testing program stored in the control unit 110 reads a signal sent from the DUT status detecting module 150 so as to obtain the start status of the DUT 300. After receiving a signal indicating that the DUT 300 is ON and finalize all the electrical connection procedures, the control unit 110 starts the testing procedure. For example, the three charging criteria, namely a constant current charging mode, a constant voltage charging mode, and a trickling charging mode are simulated. The lithium cell simulating device tests and determines whether, with the load setting module 140 having low, intermediate, and high battery levels in each of the three modes, the protection function of the DUT 300 can function well in a normal temperature status or a high temperature status.

In the above example, with the control unit 110 being in control of the programmable power supplying module 120, the lithium cell simulating device works by following the steps of: setting three simulated voltage levels of a lithium cell; setting a resistance in a normal temperature status or in a high temperature status; adjusting a charging current; connecting the lithium cell simulating device to the DUT 300; determining the start status of the DUT 300; simulating a constant current charging mode by means of a testing program; determining whether the DUT 300 interrupts a charging procedure in a normal temperature status and a high temperature status; simulating a constant voltage charging mode by means of the testing program; determining whether the DUT 300 interrupts a charging procedure in a normal temperature status and a high temperature status; simulating a trickling charging mode by means of the testing program; and determining whether the DUT 300 interrupts a charging procedure in a normal temperature status and a high temperature status.

In doing so, it is feasible to test a rechargeable cell protection mechanism quickly and easily by means of a single testing device during a process of the mass production of electronic devices.

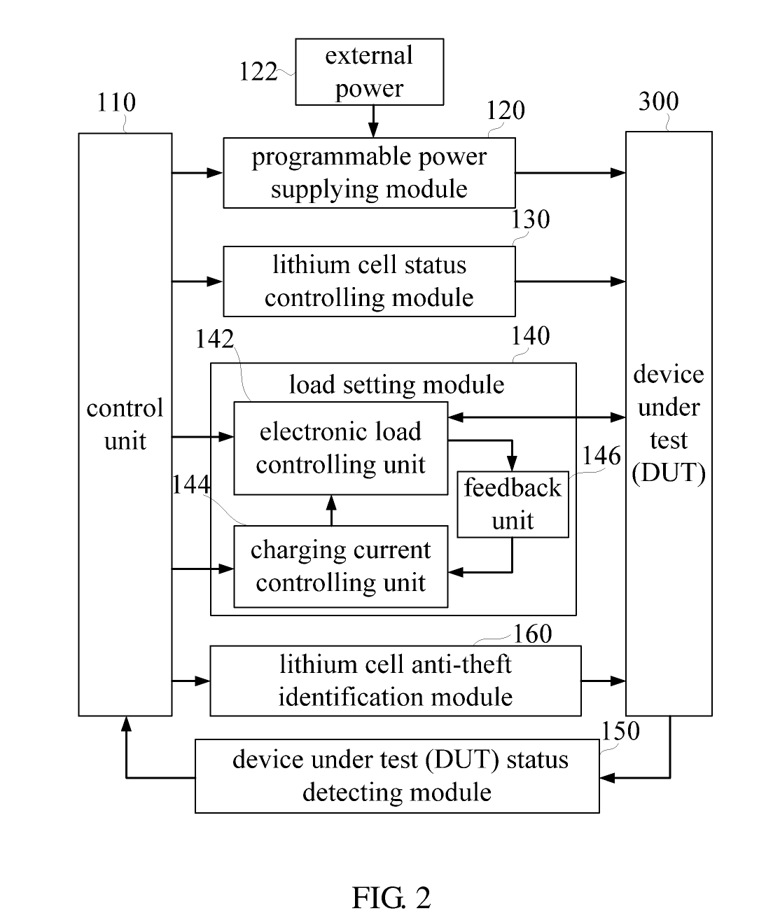

FIG. 2 is a functional block diagram of the lithium cell simulating device according to another embodiment of the present invention. In this embodiment, to be applicable to the DUT 300 having a cell locking function, the lithium cell simulating device further comprises a lithium cell anti-theft identification module 160 for providing an identifier signal to the DUT 300 for verification, such that the DUT 300 can accept the lithium cell simulating device. Upon completion of the verification, the control unit 110 starts the testing procedure only when the status signal for indicating whether the DUT 300 is ON or not indicates that the DUT 300 is ON. Hence, in the aforesaid process flow, once the DUT 300 gets connected to the lithium cell simulating device, the control unit 110 instructs the lithium cell anti-theft identification module 160 to send an identifier to the DUT 300. The DUT 300 starts only upon confirmation of a successful match. At this point, the DUT status detecting module 150 sends a signal to the control unit 110 for obtaining the start status of the DUT 300.

In short, the lithium cell simulating device of the present invention is effective in simulating a charging/discharging status, a battery level status, and a battery temperature status of a lithium cell under different conditions in the absence of the lithium cell and other complicated test apparatuses, so as to enable a great reduction of costs incurred and time taken in performing a test on a production line.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A lithium cell simulating device comprising:
a programmable power supplying module for converting an external power into a set power to be supplied to a device under test (DUT);
a lithium cell status controlling module for providing a lithium cell status signal to the DUT;
a load setting module adapted to set a battery level and a charging mode and electrically connected to the DUT so as to receive the set power via the DUT;
a control unit electrically connected to the programmable power supplying module, the lithium cell status controlling module, and the load setting module, adapted to allow the programmable power supplying module to provide the set power suitable for use by the DUT, adapted to allow the lithium cell status controlling module to set different statuses of the lithium cell according to preset testing criteria, and adapted to allow the load setting module to set different battery levels and different charging modes according to the preset testing criteria; and
a device under test (DUT) status detecting module electrically connected to the DUT and the control unit to generate a status signal for indicating whether the DUT is ON or not and send the status signal to the control unit.

2. The lithium cell simulating device of claim 1, wherein the load setting module comprises:
an electronic load controlling unit for setting, under the control of the control unit, at least three voltage levels according to at least three testing criteria, respectively, to simulate the battery levels;
a charging current controlling unit for simulating a charging of the electronic load controlling unit and setting, under the control of the control unit, at least three charging modes according to each of the testing criteria to simulate the charging modes; and
a feedback unit electrically connected to the electronic load controlling unit and the charging current controlling unit and adapted to feed back the battery level of the electronic load controlling unit to the charging current controlling unit.

3. The lithium cell simulating device of claim 2, wherein the control unit enables the electronic load controlling unit to set the battery level to a low, intermediate, and high voltage level according to the three testing criteria, and enables the charging current controlling unit to set the charging mode to a constant current charging mode, a constant voltage charging mode, or a trickling charging mode according to each of the testing criteria, so as to perform the test in the three charging modes according to each of the three testing criteria.

4. The lithium cell simulating device of claim 3, wherein the lithium cell status controlling module sets, under the control of the control unit, the lithium cell status signal to a high temperature status signal or a normal temperature status signal according to each of the testing criteria so as to test and determine whether a charging/discharging protection mechanism of the DUT is functioning well.

5. The lithium cell simulating device of claim 1, further comprising:
a lithium cell anti-theft identification module controlled by the control unit and adapted to provide an identifier signal to the DUT for verification,
wherein, upon completion of the verification, the control unit starts a testing procedure only when the status signal for indicating whether the DUT is ON or not indicates that the DUT is ON.

6. The lithium cell simulating device of claim 5, wherein the load setting module comprises:
an electronic load controlling unit for setting, under the control of the control unit, at least three voltage levels according to at least three testing criteria, respectively, to simulate the battery levels;
a charging current controlling unit for simulating a charging of the electronic load controlling unit and setting, under the control of the control unit, at least three charging modes according to each of the testing criteria to simulate the charging modes; and
a feedback unit electrically connected to the electronic load controlling unit and the charging current controlling unit and adapted to feed back the battery level of the electronic load controlling unit to the charging current controlling unit.

7. The lithium cell simulating device of claim 6, wherein the control unit enables the electronic load controlling unit to set the battery level to a low, intermediate, and high voltage level according to the three testing criteria, and enables the charging current controlling unit to set the charging mode to a constant current charging mode, a constant voltage charging mode, or a trickling charging mode according to each of the testing criteria, so as to perform the test in the three charging modes according to each of the three testing criteria.

8. The lithium cell simulating device of claim 7, wherein the lithium cell status controlling module sets, under the control of the control unit, the lithium cell status signal to a high temperature status signal or a normal temperature status signal according to each of the testing criteria so as to test and determine whether a charging/discharging protection mechanism of the DUT is functioning well.
